(19) United States
(12) Patent Application Publication
(10) Pub. No.: US 2020/0177299 A1
(43) Pub. Date: Jun. 4, 2020

(54) APPARATUS AND METHOD TO REDUCE THE IMPACT OF COHERENT CROSSTALK IN OPTICAL NETWORKS

(71) Applicant: Infinera Corporation, Annapolis Junction, MD (US)

(72) Inventor: Emilio Bravi, Hillsdale, NJ (US)

(21) Appl. No.: 16/204,428

(22) Filed: Nov. 29, 2018

(51) Int. Cl. H04J 14/02; G02B 6/293; H04B 10/2507

(52) U.S. Cl. CPC H04J 14/0205; H04J 14/0213; H04B 10/2507; G02B 6/29385; G02B 6/29383

(57) ABSTRACT

Optical networks, nodes and methods are disclosed. To solve the aggressor issue and to reduce the cross-talk caused by the aggressors in colorless, directionless and contentionless reconfigurable optical add drop multiplexer nodes, the present disclosure configures a reconfigurable filter at each port of a wavelength selective switch to permanently block one or more spectral regions that are adjacent to each wavelength (or to each group of wavelengths as in superchannels).

### INCORPORATION BY REFERENCE

Not Applicable.

### FIELD OF THE DISCLOSURE

The disclosure generally relates to methods and apparatuses for reducing the impact of coherent crosstalk in optical networks. More particularly the disclosure relates to methodologies based on spectral stop bands to reduce the impact of coherent cross in colorless, directionless, and contentionless networks where the same wavelength is present in more than one add/drop port of a wavelength selective switch.

### BACKGROUND

Wavelength division multiplexed (WDM) optical communication systems (referred to as “WDM systems”) are systems in which multiple optical signals, each having a different wavelength, are combined onto a single optical fiber using an optical multiplexer circuit (referred to as a “multiplexer”). Such systems may include a transmitter circuit, such as a transmitter (Tx) photonic integrated circuit (PIC) having a transmitter component to provide a laser associated with each wavelength, a modulator configured to modulate the output of the laser, and a multiplexer to combine each of the modulated outputs (e.g., to form a combined output or WDM signal), which may be collectively integrated onto a common semiconductor substrate.

A WDM system may also include a receiver circuit, such as a receiver (Rx) PIC, having a photodiode, and an optical demultiplexer circuit (referred to as a “demultiplexer”) configured to receive the combined output and demultiplex the combined output into individual optical signals.

A WDM system may also include a set of nodes (e.g., devices of the WDM system that may be utilized to route the multiple optical signals, add another optical signal to the multiple optical signals, drop an optical signal from the multiple optical signals, or the like). During transmission of an optical signal in a WDM system, a set of intermediate nodes, such as a set of reconfigurable add-drop multiplexers (ROADMs), may be utilized to route and/or amplify the optical signal.

ROADMs are characterized by the number of fiber optic cables that the ROADMs can be connected to. Each fiber optic cable that a particular ROADM can be connected to is referred to in the art as a “degree”. Thus, if a particular ROADM is configured to be connected to four fiber optical cables, then such ROADM is referred to in the art as having four degrees. For each degree, the ROADM has an optical device known as a wavelength selective switch connected to the fiber optic cable. The wavelength selective switch has a plurality of input ports, and functions to combine and shape the spectrum of light received at the input ports into a single combined signal that is passed onto the fiber optic cable. Shaping the light received at the plurality of input ports includes blocking optical signals having undesired wavelengths of light received at the input ports so that the single combined signal does not include the blocked optical signals. To block the undesired optical signals, each of the input ports of the wavelength selective switch includes a separate reconfigurable filter.

ROADMs may also be provided with a splitter which splits light and directs the light to ports of the wavelength selective switches. In colorless, directionless and contentionless networks, the splitter broadcasts each wavelength of light to all of the N degrees of the node and the wavelength selective switches selects, for each degree, which wavelengths are blocked and which wavelengths are let through. This selection and blocking is implemented by configuring the reconfigurable filter at each input port of the wavelength selective switch. To block a certain number M of wavelengths, the reconfigurable filter is configured to block the M wavelengths and to pass the unblocked wavelengths. Due to the imperfect isolation of the reconfigurable filter, a small fraction of the blocked wavelengths leak. If the blocked wavelength and the wavelength that is allowed through occupy the same spectral region, then this causes coherent crosstalk to the wavelength that is allowed through. These blocked wavelengths that inadvertently leak through are referred to as “aggressors”.

The reconfigurable filters in the wavelength selective switch are constituted by a combination of individually controllable “slices” of spectrum. The wavelength selective switch sets the attenuation of each individual slice of spectrum to achieve the filter shape required to either block or allow through a wavelength.

Hence, there is a need to reduce the coherent crosstalk in the unblocked wavelengths to improve the signal to noise ratio in the optical signals transmitted by the wavelength selective switch.

### BRIEF DESCRIPTION OF THE DRAWINGS

The accompanying drawings, which are incorporated in and constitute a part of this specification, illustrate one or more implementations described herein and, together with the description, explain these implementations. In the drawings:

FIG. 1 illustrates an optical communication system consistent with aspects of the present disclosure.

FIG. 2 illustrates an optical link consistent with aspects of the present disclosure.

FIG. 3 illustrates a wavelength plan for a superchannel transmitted in an optical communication system consistent with aspects of the present disclosure.

FIG. 3A Illustrates the filter response and the individual slices of a wavelength selective switch consistent with aspects of the present disclosure.

FIG. 4 illustrates an exemplary node consistent with aspects of the present disclosure.

FIG. 5 illustrates an exemplary WSS filter configuration consistent with FIG. 4 for preventing aggressors from interfering with a first carrier λ1 on port 1, by setting the reconfigurable filters at all input ports of the wavelength selective switch to block aspectral region in between the first carrier and the second carrier (stop band) in accordance with the present disclosure.

### DETAILED DESCRIPTION

The following detailed description refers to the accompanying drawings. The same reference numbers in different drawings may identify the same or similar elements.

The mechanisms proposed in this disclosure circumvent the problems described above. To solve the aggressor issue and to reduce the cross-talk caused by the aggressors as described in the background, the present disclosure configures the reconfigurable filter at each and every port of the wavelength selective switch to permanently block one or more spectral regions that are adjacent to each wavelength used as a carrier (or to each group of wavelengths used as a carrier as in superchannels). Each of these permanently blocked spectral regions is referred to herein as a “Stop-Band”. The wavelengths used as carriers need to be properly spaced in the spectrum to allow for the additional Stop-Band between adjacent carriers.

### Definitions

If used throughout the description and the drawings, the following short terms have the following meanings unless otherwise stated:

Band: The complete optical spectrum carried on the optical fiber. Depending on the fiber used and the supported spectrum which can be carried over long distances with the current technology, relevant examples of the same are: C-Band/L-Band/Extended-C-Band.

LS (Light source): A card where the digital transport client is modulate/de-modulated to/from an optical channel. This is the place where the optical channel originates/terminates.

OA (Optical Amplifier) stands for a band control gain element generally EDFA or RAMAN based.

PD (Photo-Diode) stands for a device which can measure the power levels in the complete band.

SCH (Super Channel/Optical Channel) stands for a group of wavelengths sufficiently spaced so as not to cause any interference among the group of wavelengths. The group of wavelengths may be sourced from a single light source and managed as a single grouped entity for routing and signaling in an optical network.

WSS (Wavelength Selective Switch) is a component used in optical communications networks to route (switch) optical signals between optical fibers on a per-slice basis. Generally power level controls can also be done by the WSS by specifying an attenuation level on a reconfigurable pass-band filter. A wavelength Selective Switch is a programmable device having source and destination fiber ports where the source and destination fiber ports and associated attenuation can be specified for a pass-band.

Slice stands for an N GHz (N=12.5, 6.25, 3.125) spaced frequency band of the whole of the optical spectrum each such constituent band is called a slice. A slice is the spectral resolution at which the wavelength selective switch operates to build the filter response. A channel (or super-channel) pass-band is composed of a set of contiguous slices.

### DESCRIPTION

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or more and the singular also includes the plural unless it is obvious that it is meant otherwise.

Further, use of the term “plurality” is meant to convey “more than one” unless expressly stated to the contrary.

Finally, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

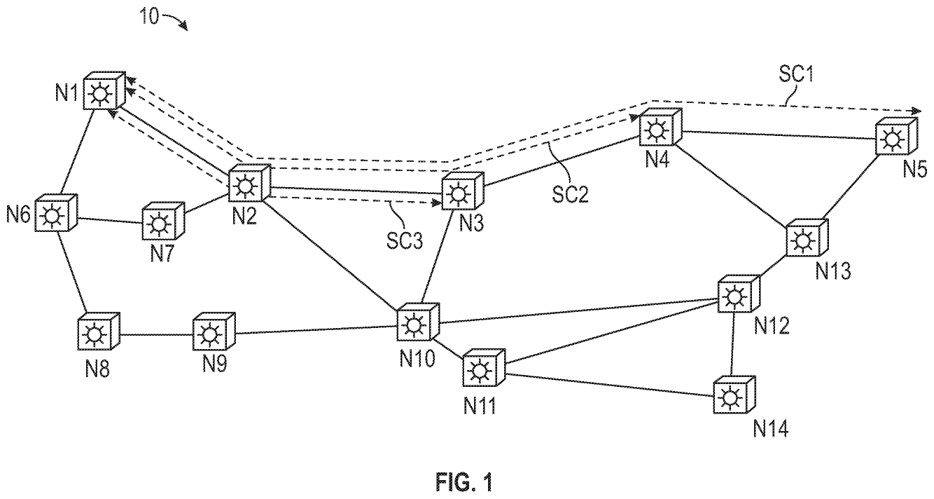

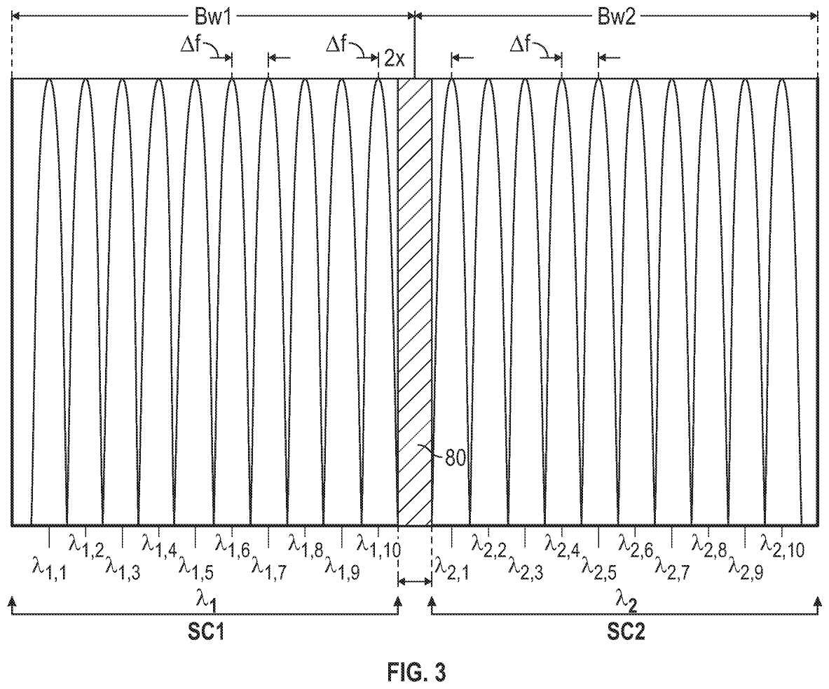

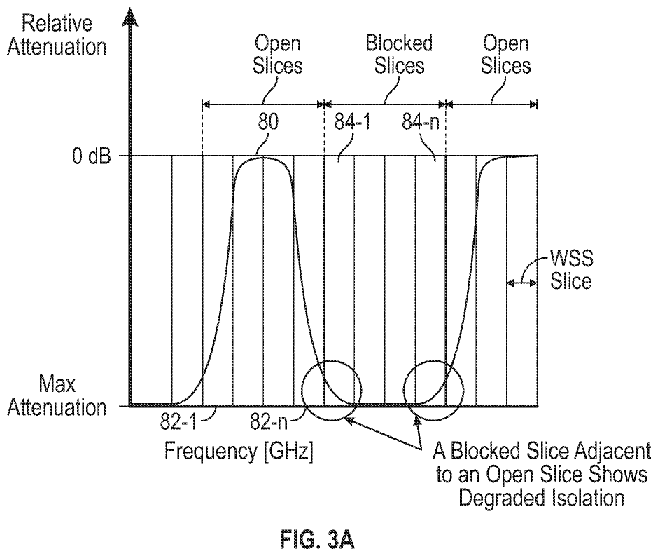

An optical communication system 10 is shown in FIG. 1. As shown, optical communication system 10 comprises a plurality of interconnected nodes N1 to N14 that may span across the United States, for example. Each node, e.g., N1 to N14, may enable high capacity WDM optical transport and digital add/drop flexibility for multiplexing a plurality of optical signals traversing the optical communication system 10. Optical signals are preferably grouped according to a plurality of superchannels SC1, SC2, for example, as described with respect to FIG. 3 below. Each node N1 to N14 preferably uses the exemplary systems and methods discussed below to transmit and receive carriers, such as superchannels, SC1, SC2, and SC3, in the optical communication system 10. The exemplary systems and methods discussed below may enable nodes N1 to N14 to convert optical signals received from interconnected nodes to the electrical domain for processing, and then convert the electrical signals back into optical signals for forwarding to other interconnected nodes. In other embodiments, at least one of the nodes N1 to N14 is a reconfigurable optical add drop multiplexer having multiple degrees which is configured to route the optical signals in the optical domain without converting the optical signals to the electrical domain for processing.

The exemplary optical communication system 10 can be implemented by deploying nodes, N1 to N14, anywhere in the network where access is desired. Some nodes may even be implemented, such as shown with respect to node N2 in FIG. 1, to simply route or pass one or more superchannels, SC1, SC2, and SC3, to other nodes in the network without processing the data that is carried by the superchannels.

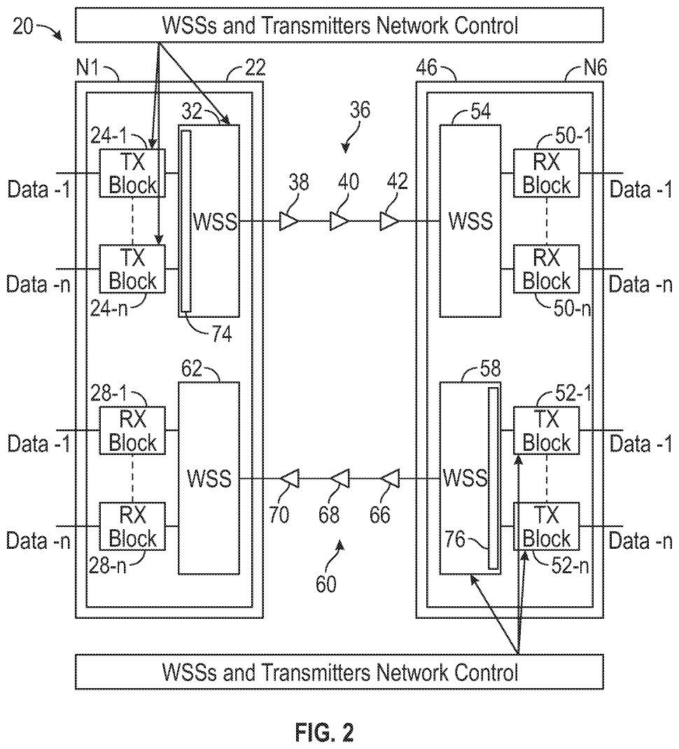

FIG. 2 illustrates a sub network 20 of the optical communication system 10 consistent with the present disclosure in which nodes N1 and N6, for example, include transmitter blocks and receiver blocks.

As shown in FIG. 2, the node N1 includes a first rack, cabinet, chassis, or housing 22, which includes a plurality of transmitter blocks (Tx Block) 24-1 to 24-n, and a plurality of receiver blocks (Rx Block) 28-1 to 28-n. Similar to the above, each of the transmitter blocks 24-1 to 24-n receives a corresponding one of a plurality of data or information streams Data-1 to Data-n, and, in response to a respective one of these data streams, each of transmitter blocks 24-1 to 24-n may output a group of optical signals or a superchannel to a wavelength selective switch 32, which multiplexes a plurality of superchannels together onto optical communication path 36. As shown, optical communication path 36 may include one or more segments of optical fiber and optical amplifiers 38, 40, and 42, for example, to optically amplify or boost the power of the transmitted optical signals.

As further shown in FIG. 2, the sub network 20 includes a second rack, cabinet, chassis, or housing 46, which includes a plurality of receiver blocks 50-1 to 50-n and a plurality of transmitter blocks 52-1 and 52-n. A wavelength selective switch 54 may include one or more optical filters, for example, and supply each group of received optical signals to a corresponding one of receiver blocks (Rx Blocks) 50-1 to 50-n. Each of receiver blocks 50-1 to 50-n, in turn, supplies a corresponding copy of data or information streams Data-1 to Data-n in response to the optical signals. Transmitter blocks 52-1 to 52-n and wavelength selective switch 58 function similarly as transmitter blocks 24-1 to 24-n and wavelength selective switch 32 provided in housing 22 in order to provide bi-directional communication via a communication path 60 between interconnected nodes N2 to N6 shown in FIG. 1. Accordingly, receiver blocks 28-1 to 28-n and wavelength selective switch 62 also function similarly as receiver blocks 50-1 to 50-n and wavelength selective switch 54, respectively. As shown, optical communication path 60 also may include one or more segments of optical fiber and optical amplifiers 66, 68, and 70, for example, to optically amplify or boost the power of the transmitted optical signals. The wavelength selective switches 32 and 58 include reconfigurable filters 74 and 76 that can be configured to include stop bands in the spectrum between adjacent carriers as discussed herein.

As further shown in FIG. 2, the subnetwork 20 also includes at least one network controller 78 that communicates with the transmitter blocks 24-1-24-n, and 52-1-52-n, and wavelength selective switches 32 and 58. The network controller 78 includes network control software stored on a non-transitory computer readable medium, that makes sure that the reconfigurable filters 74 and 76 of the are configured as discussed herein, e.g., are centered around a wavelength added by the transmitter blocks 24-1-24-n, and 52-1-52-n. The network control software is run on a suitable processor, such as a microprocessor, FPGA, digital signal processor or the like to send configuration instructions to the reconfigurable filters 74 and 76. The term processor, as used herein, refers to a single processor or multiple processors working together.

FIG. 3A shows a filter response of the reconfigurable filter 74 of the wavelength selective switch 32, for example. The reconfigurable filter 74 that is configured on a slice-by-slice basis as shown by the vertical lines in FIG. 3A. For each slice, the reconfigurable filter 74 can be configured to either pass the light within the slice (this is known as an “open slice”) or block the light within the slice (this is known as a “blocked slice”). To pass a carrier frequency 80, for example, multiple slices 82-1 to 82-n of the reconfigurable filter 13 can be set to open. As shown in FIG. 3A, a series of adjacent open slices shows an ideal behavior with a flat response of 0 dB attenuation. Similarly, a series of blocked slices 84-1 to 84-n shows an ideal behavior with a flat response of max attenuation. However, because of the non-ideal response of the reconfigurable filter 74 for the wavelength selective switch 32, for example, an open slice followed by a blocked slice shows a roll-off effect that needs to be accounted for in a wavelength channel plan. The common way to deal with this non-ideal filtering effect is by allocating enough spectrum in between channels (or superchannels) so that the roll-off can be accommodated for. For example, in FIG. 3A channels should occupy a spectral region only slightly wider than the two central slices of the “open slice” group and leave the remaining 2 open slices almost un-occupied to avoid filtering effects. Therefore, the channels (or superchannel) spectral spacing must be increased to accommodate for these un-occupied slices. This additional spectral spacing allocated in between channels (or superchannels), is referred to in the art as a “guard-band.” Conventionally, the wavelength selective switch 32 always keeps the slices related to the guard-band of a channel to be passed in an open state.

FIG. 3A also shows that a blocked slice followed by an open slice does not have an ideal behavior: the isolation of these blocked slices is reduced. This effect causes additional leakage of light and increases the coherent crosstalk caused by the presence of “aggressors” wavelengths.

FIG. 3 shows a wavelength channel plan with the presence of a guard band 80. The optical signals or carriers included in each group or band are centered around a wavelength or frequency specified by the International Telecommunications Union (ITU) standard wavelength or frequency grid. Alternatively, each of the optical carriers is provided according to a unique nonstandard grid that is optimized for a specific embodiment. For example, as shown in FIG. 3, a plurality of optical signals or carriers λ1,1 to λ1,10 are grouped or banded together to form a superchannel SC1, and a plurality of optical signals or carriers λ2,1 to λ2,10 are grouped or banded together to form a superchannel SC2. As shown, the plurality of sub-wavelength channels λ1,1 to λ1,10 and λ2,1 to λ2,10 are closely spaced so as to optimize the occupied bandwidth BW1 and BW2 of the superchannels SC1 and SC2, respectively. Each carrier λ1,1 to λ1,10 and λ2,1 to λ2,10 of SC1 and SC2, respectively, may be considered a sub-wavelength channel banded around a center wavelength λ1 and λ2 identifying the superchannels SC1 and SC2, respectively. As described above, each of the superchannels SC1 and SC2 may be multiplexed or independently routed through the optical communication system 10 shown in FIG. 1.

In an exemplary embodiment, the plurality of sub-wavelength channels or carriers λ1,1 to λ1,10 and λ2,1 to λ2,10 are preferably periodically spaced from each other by a fixed frequency spacing according to an embodiment specific unique frequency grid. In other words, as shown in FIG. 3, a corresponding frequency spacing between the center wavelengths λ1,1 and λ1,2, shown as Δf, is the same for each of the other carriers in a superchannel. Thus, each of the carriers are said to be periodically spaced from each other by Δf. Because a transmit node 11′ can produce a plurality of superchannels λ1 to λn, as shown in FIG. 2, in order to utilize common optical components for each superchannel, it is preferred that the carriers for each superchannel utilize the same fixed frequency spacing Δf as shown in FIG. 3.

It is understood that the characteristics of optical components can vary with respect to temperature and other environmental conditions. Thus, throughout the disclosure where a “fixed” frequency or wavelength spacing is described, such fixed spacing is a theoretical or ideal fixed spacing that is desired, but may not be achieved exactly due to environmental conditions. Thus, any substantially similar spacing, frequency or wavelength within expected optical component variations may correspond to the ideal fixed spacing described.

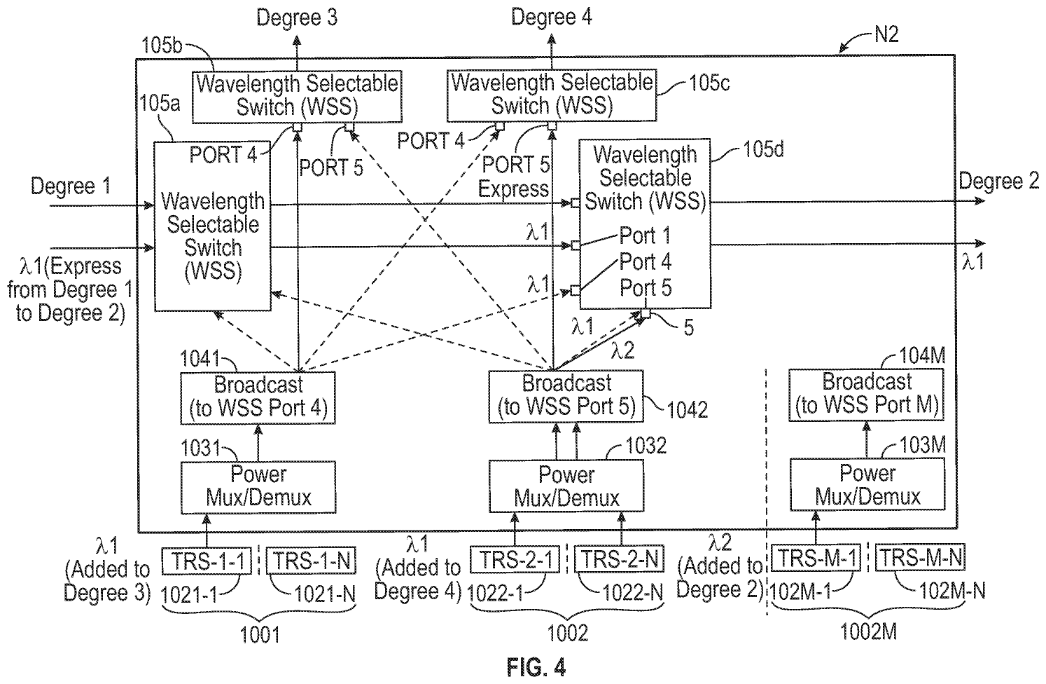

As shown in FIG. 4, node N2 may be a colorless, directionless, and contentionless node based on route and select architecture and on broadcasted add wavelengths. In this example node N2 is a four degree node in which up to N different wavelengths, transmitted by M number of transmitter sets 100 (labeled as 100_{1-M}) of a number N of transmitters 102 (labeled as 102_{M-N}), are combined with multiplexers 103_{1-M.}. A plurality of broadcast modules 104_{1-M} within node N2 then splits the combined signal in a certain number of replicas and each replica is sent to a different mux/demux 105a, 105b, 105c and 105d. The mux/demux 1055a-d can be wavelength selective switches. Each of the mux/demux 105a-d have a plurality of input ports, which are shown by way of example and brevity on mux/demux 5d as input ports “port 1”, “port 4” and “Port 5”. The mux/demux 105a, 105b, 105c and 105d can have more or less ports and specific input ports are shown by way of example. Each of the input ports of the mux/demux 105a, 105b, 105c and 105d is associated with a reconfigurable filter, such as the reconfigurable filter 74 shown by way of example in FIG. 2.

In FIG. 4, it is assumed that certain of the input ports of the mux/demux 105d are used to express the four degrees, and the rest of the input ports are used for Add/Drop. In this example input ports 4 and 5 are specifically shown and used for Add/Drop purposes. In this example, λ₁ is received on the mux/demux 105a and passed to Port 1 of mux/demux 105d. The wavelength λ₁ is also generated by the transmitter sets 106_{1-M} from transmitters 102₁₋₁ and 102₂₋₁ and then replicated by the broadcast modules 104₁ and 104₂ such that a replica of λ₁ from transmitter 102₁₋₁ is present at port 4 on each of the mux/demux 5a-d, and a replica of λ₁ from transmitter 2₁₋₂ is present at port 5 on each of the mux/demux 5a-d. Therefore, the mux/demux 105d of degree 2 has to let through the expressed wavelength λ₁ (from degree 1) and the mux/demux 105d has to block the wavelength λ₁ present at port 4 and the wavelength λ₁ present at port 5. In this example, the reconfigurable filters at ports 4 and 5 of mux/demux 105d are configured to block λ₁ and any stopbands in the wavelength channel plan. Port 5 receives both λ₁ and λ₂ and has the reconfigurable filter configured to pass λ₂, and block λ₁ and any stopbands in the wavelength channel plan.

More in general, an N-degree node may have up to N−1 times the same wavelength at the add port of the mux/demux 105 (WSS) of each degree, one wavelength at each input port. As shown in FIG. 4, the wavelength λ₂ is generated by the transmitter 102_{2-N} of the transmitter set 1066₂. Due to the imperfect isolation of the reconfigurable filters at each input port of the mux/demux 105d, a small fraction of the blocked wavelength may leak, causing coherent crosstalk to the wavelength that is allowed through. These blocked wavelengths are referred to as “aggressors”. To prevent the leakage of the blocked wavelength, the present disclosure proposes that the reconfigurable filter for each input port of the mux/demux 105 a-d to always block the sub-band adjacent to every carrier (or set of carriers as in superchannels), including both blocked and allowed through carriers. The channel plan has to include the presence of these blocked sub-bands and the transmitters 102M-N have to tune the carriers accordingly.

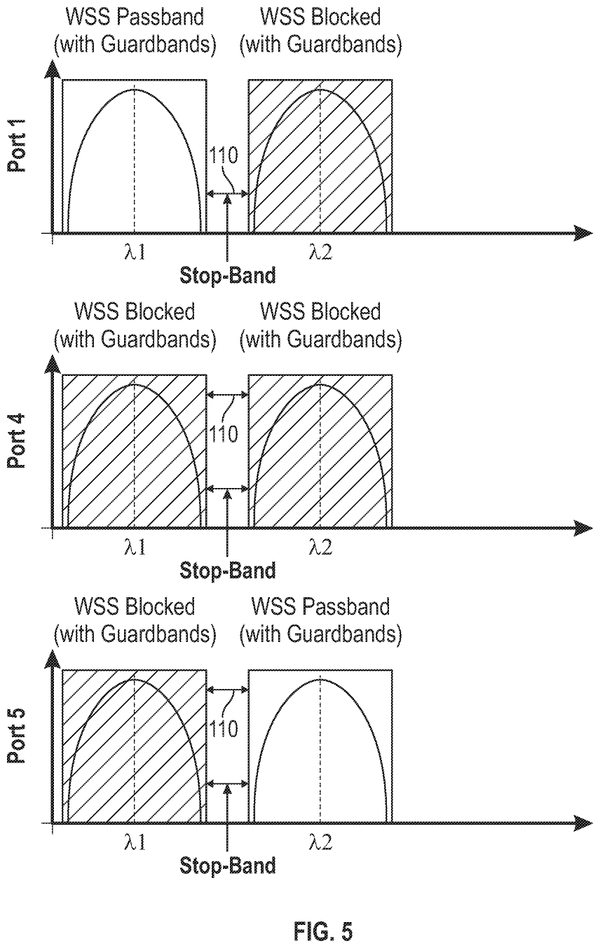

Referring to FIG. 5, the filter configuration of port 1, port 4 and port 5 of the WSS 105d in FIG. 4 are shown. Each of these ports either allows through or block the adjacent carriers denoted as λ₁, λ₂. These carriers will be either blocked or allowed through by the wavelength selective switch, by setting the corresponding bandwidth (which include the guardband) to close or open respectively. The spectral stop band 110, is located in between the carriers λ₁ and λ₂. The reconfigurable filters at all of the input ports of the mux/demux 105d, (e.g., wavelength selective switch) are set to block the stop band 110. In this way, it is guaranteed that a blocked wavelength in the mux/demux 105d (e.g., WSS) is surrounded by an additional blocked stop-band 110. Therefore, a wavelength is always blocked with an ideal isolation and the leakage of light is minimized. The filter configuration for mux/demux 105d is shown by way of example in FIG. 5. It should be understood that the input ports of the mux/demux 105a-c can be configured in a similar manner with stop bands 110 to minimize the leakage of light into the carriers that are desired to be passed.

### CONCLUSION

The mechanisms proposed in this disclosure circumvent the problems described above. To solve the aggressor issue and to reduce the cross-talk caused by the aggressors as described in the background, the present disclosure configures the reconfigurable filter at each port of the wavelength selective switch to permanently block one or more spectral regions that are adjacent to each wavelength used as a carrier (or to each group of wavelengths used as a carrier as in superchannels). The wavelengths need to be properly spaced to allow for the additional blocked regions.

The foregoing description provides illustration and description, but is not intended to be exhaustive or to limit the inventive concepts to the precise form disclosed. Modifications and variations are possible in light of the above teachings or may be acquired from practice of the methodologies set forth in the present disclosure.

Even though particular combinations of features are recited in the claims and/or disclosed in the specification, these combinations are not intended to limit the disclosure. In fact, many of these features may be combined in ways not specifically recited in the claims and/or disclosed in the specification. Although each dependent claim listed below may directly depend on only one other claim, the disclosure includes each dependent claim in combination with every other claim in the claim set.

No element, act, or instruction used in the present application should be construed as critical or essential to the invention unless explicitly described as such outside of the preferred embodiment. Further, the phrase “based on” is intended to mean “based, at least in part, on” unless explicitly stated otherwise.

1. An apparatus, comprising:
a first optical transmitter configured to supply a plurality of first optical signals, each of the plurality of first optical signals being spaced apart from one another spectrally, the plurality of first optical signals constituting a first superchannel, each of the plurality of first optical signals having a corresponding one of a plurality of first wavelengths;
a second optical transmitter configured to supply a plurality of second optical signals, each of the plurality of second optical signals being spaced apart from one another spectrally, the plurality of second optical signals constituting a second superchannel, each of the plurality of second optical signals having a corresponding one of a plurality of second wavelengths, wherein a maximum one of the plurality of first wavelengths and a minimum one of the plurality of second wavelengths are spaced apart spectrally from one another encompassing a stop-band of a spectrum centered around a third wavelength, the stop-band being devoid of carriers;
a wavelength selective switch having a first input port and a second input port, the first input port receiving the plurality of first optical signals and the plurality of second optical signals,
a first reconfigurable filter associated with the first input port and configured to block the first optical signals, and pass the second optical signals, and
a second reconfigurable filter associated with the second input port and configured to block the second optical signals, and pass the first optical signals,
wherein the wavelength selective switch is configured to combine the first superchannel and the second superchannel, and wherein the first reconfigurable filter and the second reconfigurable filter are configured to block the stop-band of the spectrum centered around the third wavelength.

2. The apparatus of claim 1, wherein the first optical signals are spaced apart spectrally by a first spacing, and the stop-band is spaced apart spectrally by a second spacing, and wherein the second spacing is greater than the first spacing.

3. The apparatus of claim 1, wherein the wavelength selective switch is a first wavelength selective switch, and wherein the first optical signals are passed through a second wavelength selective switch prior to being received by the first input port, the first and second wavelength selective switches being a part of a first node, and the first optical transmitter being a part of a second node different from the first node.

4. The apparatus of claim 1, wherein the wavelength selective switch, the first optical transmitter, and the second optical transmitter are a part of a colorless, directionless and contentionless reconfigurable optical add drop multiplexer node.

5. An optical device, comprising:
a wavelength selective switch having a first input port receiving a first optical signal encompassing a first carrier centered around a first wavelength, a second input port receiving a second optical signal encompassing the first carrier, the wavelength selective switch further comprising a first reconfigurable filter associated with the first input port and configured to pass the first optical signal encompassing the carrier, and a second reconfigurable filter associated with the second input port and configured to block a stop-band within the spectrum encompassing the first carrier, the first and second reconfigurable filters being configured to block a second carrier, the second carrier adjacent to the first carrier and having a second wavelength less than the first wavelength, the wavelength selective switch including a combiner for combining a first output of the first reconfigurable filter, and a second output of the second reconfigurable filter, the stop-band being device of channels.

6-7. (canceled)

8. The optical device of claim 5, wherein the second reconfigurable filter is configured independent of any predetermined selection of the second optical signals received by the second port.

9. A method, comprising:
in a colorless, directionless, and contentionless reconfigurable optical add drop multiplexer node having a wavelength selective switch having a first input port receiving a first optical signal, a second input port receiving a second optical signal, a first reconfigurable filter associated with the first input port, and a second reconfigurable filter associated with the second input port, the wavelength selective switch configured to combine the first optical signal passed by the first reconfigurable filter and the second optical signal passed by the second reconfigurable filter, wherein the first optical signal and the second optical signal are spaced apart spectrally from one another by a stop-band of the spectrum,
configuring the first reconfigurable filter to block the second optical signal and pass the first optical signal;
configuring the second reconfigurable filter to block the first optical signal and pass the second optical signal; and
configuring the first reconfigurable filter and the second reconfigurable filter to block the stop-band of the spectrum between the first optical signal and the second optical signal, the stop-band being devoid of carriers.

10. The method of claim 9, further comprising the step of developing a wavelength channel plan wherein the sub-band of the spectrum between the first optical signal and the second optical signal is blocked, and wherein the step of configuring the first reconfigurable filter and the second reconfigurable filter is defined further as configuring the first reconfigurable filter and the second reconfigurable filter in accordance with the wavelength channel plan, to block the sub-band of the spectrum.
